(19) United States
(12) Patent Application Publication
(10) Pub. No.: US 2014/0251275 A1
(43) Pub. Date: Sep. 11, 2014

(54) FUEL INJECTOR FUELING EQUALIZATION SYSTEM AND METHOD

(71) Applicant: CUMMINS INC., Columbus, IN (US)

(72) Inventor: Carlos A. LANA, Columbus, IN (US)

(73) Assignee: CUMMINS INC., Columbus, IN (US)

(21) Appl. No.: 13/791,682

(22) Filed: Mar. 8, 2013

(51) Int. Cl. F02M 69/04

(52) U.S. Cl. CPC F02M 69/04
USPC 123/452

(57) ABSTRACT

The disclosure provides a system and method for detecting inhomogeneous fueling between fuel injectors in an internal combustion engine without resorting to a measurement of the amount of fuel delivered by each fuel injector, permitting rapid and effective adjustment of fueling by any fuel injector deviating from the homogeneity of other fuel injectors in the engine. The benefit of modifying fueling in this manner is that fueling by each fuel injector 38 is balanced independent of actual measurements of fuel delivery, simplifying the process of correcting cylinder-to-cylinder fueling imbalances. The described system and method require no intrusion into a fueling system of the engine and uses currently existing components.

### TECHNICAL FIELD

This disclosure relates to a system and method for analyzing pressure data signals from a fuel accumulator of an internal combustion engine and adjusting a fuel injector on-time based on a comparison of a cycle mean pressure during an engine cycle to a period mean pressure of an injection period for each fuel injector.

### BACKGROUND

As with all mechanical devices, fuel injectors have physical dimensions that lead to variations between fuel injectors. In addition, each fuel injector has a different rate of wear and responds to temperature changes differently. Since the fuel delivered by each fuel injector during a fuel injection event varies enough to affect the performance of an associated engine, it is useful to adjust the amount of fuel delivered by each fuel injector.

### SUMMARY

This disclosure provides a method of adjusting an amount of fuel delivered by a fuel injector of an internal combustion engine having a plurality of fuel injectors. The method comprises determining a number of injection periods in an engine cycle, calculating a period mean pressure in a fuel accumulator for each injection period in the engine cycle, and calculating a cycle mean pressure in the fuel accumulator for the engine cycle. Each injection period includes a portion of an injection event and has an equal length. The engine cycle includes one injection event from each one of the plurality of fuel injectors. The method also comprises comparing the period mean pressure for each fuel injector to the cycle mean pressure, and calculating an on-time for each fuel injector based on the comparison of the period mean pressure to the cycle mean pressure.

This disclosure also provides an internal combustion engine comprising a control system, a fuel accumulator, a pressure sensor, a plurality of fuel injectors, a rotatable engine shaft, and an angle sensor. The pressure sensor is fluidly connected to the fuel accumulator and adapted to transmit a pressure signal indicative of a pressure in the fuel accumulator. The plurality of fuel injectors is fluidly connected to the fuel accumulator, each fuel injector of the plurality of fuel injectors being adapted to receive a control signal from the control system and having an on-time in response to the control signal, the on-time corresponding to an injection event. The angle sensor is associated with the rotatable engine shaft and adapted to transmit an angle signal indicative of an angle of rotation of the rotatable engine shaft. The control system is adapted to receive the angle signal and the pressure signal during an engine cycle. The engine cycle is divided into a plurality of injection periods, including one injection period for each fuel injector. The control system is adapted to calculate a period mean pressure for each injection period, to calculate a cycle mean pressure for the engine cycle, to calculate a difference between each period mean pressure and the cycle mean pressure, and to use each difference to adjust the on-time for each fuel injector corresponding to the calculated difference.

This disclosure also provides an internal combustion engine, comprising a control system, a fuel accumulator, a pressure sensor, a plurality of fuel injectors, a rotatable engine shaft, and an angle sensor. The pressure sensor is fluidly connected to the fuel accumulator and adapted to transmit a pressure signal indicative of a pressure in the fuel accumulator. The plurality of fuel injectors is fluidly connected to the fuel accumulator, each fuel injector of the plurality of fuel injectors being adapted to receive a control signal from the control system and having an on-time in response to the control signal, the on-time corresponding to an injection event. The angle sensor is associated with the rotatable engine shaft and is adapted to transmit an angle signal indicative of the angle of rotation of the rotatable engine shaft. The control system is adapted to receive the angle signal and the pressure signal for an engine cycle of 720 degrees of operation of the rotatable engine shaft. The engine cycle is divided into a plurality of injection periods calculated by dividing 720 degrees by the number of fuel injectors in the plurality of fuel injectors. Each injection period extends from a crank angle at or prior to a beginning of the injection event to a crank angle after an end of the injection event and each injection period has the same crank angle length. The control system is adapted to calculate a period mean pressure for each injection period, to calculate a cycle mean pressure for the engine cycle, to calculate a difference between each period mean pressure and the cycle mean pressure, and to use each difference to adjust the on-time for each fuel injector corresponding to the calculated difference.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 is a schematic of an internal combustion engine incorporating an exemplary embodiment of the present disclosure.

FIG. 2 is a data acquisition, analysis and control (DAC) module of the engine of FIG. 1 in accordance with an exemplary embodiment of the present disclosure.

FIG. 3 is a graph showing homogeneous fueling of the engine of FIG. 1.

FIG. 4 is a graph showing inhomogeneous fueling of the engine of FIG. 1.

FIG. 5 is a graph showing an injection period that may be defined in accordance with an exemplary embodiment of the present disclosure.

### DETAILED DESCRIPTION

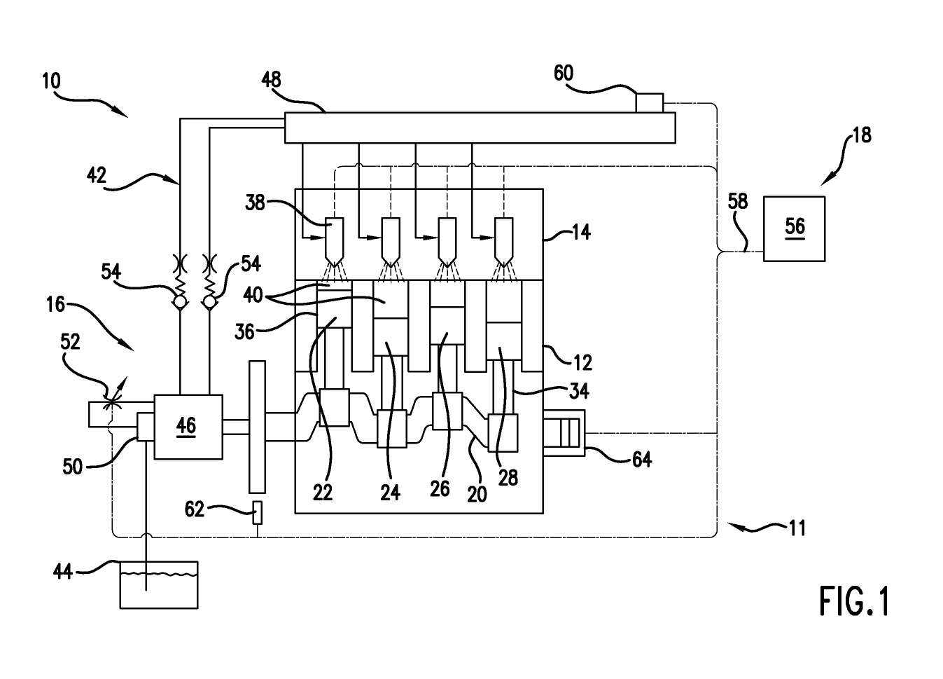

Referring to FIG. 1, a portion of an internal combustion engine is shown as a simplified schematic and generally indicated at 10. Engine 10 includes an engine body 11, which includes an engine block 12 and a cylinder head 14 attached to engine block 12, a fuel system 16, and a control system 18. Control system 18 receives signals from sensors located on engine 10 and transmits control signals to devices located on engine 10 to control the function of those devices, such as one or more fuel injectors.

One challenge with fuel injectors is that they have a measure of variability from injector-to-injector, leading to a variation in fuel quantity or amount delivered by the fuel injectors. In addition, the temperature of a fuel injector and wear of components in a fuel injector may cause additional variation in fuel quantity delivered by an individual injector during a fuel injection event, which corresponds to a fuel injector on-time. The variation in fuel quantity delivered causes undesirable variations in output power in engine 10, causes undesirable variation in emissions, e.g., NOX and CO, and causes mechanical vibrations due to fueling imbalances. In order to combat these undesirable effects, techniques of measuring fuel delivery by each fuel injector have been developed. However, these techniques have their own undesirable side effects. Engine 10 of the present disclosure includes a system and method for detecting inhomogeneous fueling between fuel injectors, which causes cylinder-to-cylinder fueling variations, without resorting to a measurement of the amount of fuel delivered, permitting rapid and effective adjustment of fueling by any fuel injector deviating from the homogeneity of fueling by the other fuel injectors in engine 10 by adjusting the on-time of the fuel injector. The benefit of modifying the fuel injector on-time in this manner is that fueling by each fuel injector is balanced independent of actual measurements of fuel delivery, thus requiring no intrusion into fuel system 16 and simplifying the process of correcting cylinder-to-cylinder fueling imbalances. The described system and method uses currently existing components, requiring only minor modifications of control system 18.

In the exemplary embodiment, engine body 12 includes a crankshaft 20, a #1 piston 22, a #2 piston 24, a #3 piston 26, a #4 piston 28, a plurality of connecting rods 34, and a plurality of fuel injectors 38. Pistons 22, 24, 26, and 28 are positioned for reciprocal movement in a plurality of engine cylinders 36, with one piston positioned in each engine cylinder 36. One connecting rod 34 connects each piston to crankshaft 20. As will be seen, the movement of the pistons under the action of a combustion process in engine 10 causes connecting rods 34 to move or rotate crankshaft 20.

In the exemplary embodiment, four fuel injectors 38 are positioned within cylinder head 14. Each fuel injector 38 is fluidly connected to a combustion chamber 40, each of which is formed by one piston, cylinder head 14, and the portion of engine cylinder 36 that extends between the piston and cylinder head 14. While the exemplary embodiment includes four pistons, combustion chambers 40, and fuel injectors 38, the system and method of the present disclosure may operate with as few as two fuel injectors and with as many fuel injectors as any engine is capable of containing.

Fuel system 16 provides fuel to injectors 38, which is then injected into combustion chambers 40 by the action of fuel injectors 38, forming one or more injection events. Fuel injector 38 may include a nozzle valve or needle valve element (not shown) that moves from a closed position to an open position and then from the open position to the closed position, forming the injection event. The nozzle or needle valve element may move from the closed position to the open position when fuel injector 38 is energized by control system 18 to inject fuel into combustion chamber 40 during an injection event. The nozzle or needle valve element remains open for a period, which we call on-time and which corresponds to the injection event, that provides a predetermined volume, amount, or quantity of fuel to combustion chamber 40, as determined by control system 18 based on engine operation state and inputs to engine 10, such as acceleration, torque or power, engine speed, and fuel pressure. At the end of the predetermined period, control system 18 de-energizes fuel injector 38, which causes the nozzle or needle valve element to close, ending the injection event. While the nozzle or needle valve element is described as opening when energized and closing when de-energized, fuel injector 38 may also operate in an opposite manner where the nozzle or needle valve element opens when de-energized and closes when energized. Fuel injector 38 may be similar to the fuel injectors disclosed in U.S. Pat. Nos. 6,253,736 and 8,201,543, which are hereby incorporated by reference in their entirety.

Fuel system 16 includes a fuel circuit 42, a fuel tank 44, which contains a fuel, a high-pressure fuel pump 46 positioned along fuel circuit 42 downstream from fuel tank 44, and a fuel accumulator or rail 48 positioned along fuel circuit 42 downstream from high-pressure fuel pump 46. In the exemplary embodiment, fuel accumulator 48 is shown as a single device, which has certain advantages, such as a reduction of pressure oscillations in the high-pressure portions of fuel circuit 42, a central location for storage of high-pressure fuel for engine 10, and other advantages. However, in some fuel systems the elements that contain high-pressure fuel, including the fuel injectors, any fuel lines, pipes, hoses, and the like, serve to function as fuel accumulator 48.

Fuel system 16 may include an inlet metering valve 52 positioned along fuel circuit 42 upstream from high-pressure fuel pump 46. Fuel system 16 may further include one or more outlet check valves 54 positioned along fuel circuit 42 downstream from high-pressure fuel pump 46 to permit one-way fuel flow from high-pressure fuel pump 46 to fuel accumulator 48. Alternatively, fuel system 16 may include solenoid valves (not shown) positioned between high-pressure fuel pump 46 and fuel accumulator 48. Inlet metering valve 52, the solenoids valves, or another device, has the ability to vary or shut off fuel flow to high-pressure fuel pump 46 or from high-pressure fuel pump 46 to fuel accumulator 48. Fuel circuit 42 connects fuel accumulator 48 to fuel injectors 38, which receive fuel from fuel circuit 42 and then provide controlled amounts of fuel to combustion chambers 40 during injection events that are defined by the on-time of each fuel injector 38. Fuel system 16 may also include a low-pressure fuel pump 50 positioned along fuel circuit 42 between fuel tank 44 and high-pressure fuel pump 46. Low-pressure fuel pump 50 increases the fuel pressure to a first pressure level prior to fuel flowing into high-pressure fuel pump 46, which increases the efficiency of operation of high-pressure fuel pump 46. The pumping events of high-pressure fuel pump 46 must be synchronized with engine 10 rotation so that the number of pumping events between each injection event is an integer number greater or equal than 1 and the integer number of pumping events between each injection event needs to be identical. In addition, the timing of pumping events with respect to each injection event is preferably the same. Other fuel systems having a configuration different from fuel system 16 exist that provide the capability of pumping high-pressure fuel to fuel accumulator 48 or its equivalent, and thus the description of the pumping portion of fuel system 16 should be considered as exemplary alternatives rather than being limiting. The pumping system described hereinabove may be described as a discrete pumping system. Other systems that provide a continuous fuel output or quasi-continuous fuel output, such as might be seen from a gear pump, may not need to be synchronized with the injection events.

Control system 18 may include a control module 56 and a wire harness 58. Many aspects of the disclosure are described in terms of sequences of actions to be performed by elements of a computer system or other hardware capable of executing programmed instructions, for example, a general-purpose computer, special purpose computer, workstation, or other programmable data process apparatus. It will be recognized that in each of the embodiments, the various actions could be performed by specialized circuits (e.g., discrete logic gates interconnected to perform a specialized function), by program instructions (software), such as program modules, being executed by one or more processors (e.g., one or more microprocessors, a central processing unit (CPU), and/or application specific integrated circuit), or by a combination of both. For example, embodiments can be implemented in hardware, software, firmware, microcode, or any combination thereof. The instructions can be program code or code segments that perform necessary tasks and can be stored in a non-transitory machine-readable medium such as a storage medium or other storage(s). A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents.

The non-transitory machine-readable medium can additionally be considered to be embodied within any tangible form of computer readable carrier, such as solid-state memory, magnetic disk, and optical disk containing an appropriate set of computer instructions, such as program modules, and data structures that would cause a processor to carry out the techniques described herein. A computer-readable medium may include the following: an electrical connection having one or more wires, magnetic disk storage, magnetic cassettes, magnetic tape or other magnetic storage devices, a portable computer diskette, a random access memory (RAM), a read-only memory (ROM), an erasable programmable read-only memory (e.g., EPROM, EEPROM, or Flash memory), or any other tangible medium capable of storing information. It should be noted that the system of the present disclosure is illustrated and discussed herein as having various modules and units that perform particular functions.

It should be understood that these modules and units are merely described based on their function for clarity purposes, and do not necessarily represent specific hardware or software. In this regard, these modules, units and other components may be hardware and/or software implemented to substantially perform their particular functions explained herein. The various functions of the different components can be combined or segregated as hardware and/or software modules in any manner, and can be useful separately or in combination. Input/output or I/O devices or user interfaces including, but not limited to, keyboards, displays, pointing devices, and the like can be coupled to the system either directly or through intervening I/O controllers. Thus, the various aspects of the disclosure may be embodied in many different forms, and all such forms are contemplated to be within the scope of the disclosure.

In the exemplary embodiment, engine 10 also includes an accumulator pressure sensor 60 and a crank angle sensor. Other devices may be used in place of pressure sensor 60 that provide an output that varies with pressure, such as a force sensor, which operates in an equivalent manner for the purposes detailed in this disclosure. In embodiments where the fuel accumulator is embodied in a plurality of high-pressure components, such as fuel lines, pipes, hose, and the like, the fuel injector, and any other high-pressure elements, a pressure sensor may be positioned along any portion of the fuel circuit containing the high pressure that feeds the fuel injectors. The crank angle sensor may be a toothed wheel sensor 62, a rotary Hall sensor 64, or other type of device capable of measuring the rotational angle of crankshaft 20. While the exemplary embodiment describes the crank angle sensor as measuring the angle of rotation of crankshaft 20, the crank angle sensor may measure the rotational angle of any rotatable engine shaft, which includes crankshaft 20, and thus may be more broadly described as an angle sensor. A mathematical correction factor may need applied if the rotatable engine shaft is not crankshaft 20 and if there is a difference between the amount of rotation of the rotatable engine shaft and crankshaft 20. Control system 18 uses signals received from accumulator pressure sensor 60 and the angle sensor to determine the combustion chamber receiving fuel, which is then used to analyze the signals received from accumulator pressure sensor 60, described in more detail hereinbelow. Control system 18 also uses signals from accumulator pressure sensor 60 to control a mean rail or fuel accumulator 48 pressure to a target pressure value, for example, 1500 bar or 2500 bar. This target pressure value is derived from an engine operating condition that may be determined at least in part by load on the engine and by required engine speed.

Control module 56 may be an electronic controller or control unit or electronic control module (ECM) that may monitor conditions of engine 10 or an associated vehicle in which engine 10 may be located. Control module 56 may be a single processor, a distributed processor, an electronic equivalent of a processor, or any combination of the aforementioned elements, as well as software, electronic storage, fixed lookup tables and the like. Control module 56 may include a digital or analog circuit. Control module 56 may connect to certain components of engine 10 by wire harness 58, though such connection may be by other means, including a wireless system. For example, control module 56 may connect to and provide control signals to inlet metering valve 52 and to fuel injectors 38.

When engine 10 is operating, combustion in combustion chambers 40 causes the movement of pistons 22, 24, 26, and 28. The movement of pistons 22, 24, 26, and 28 causes movement of connecting rods 34, which are drivingly connected to crankshaft 20, and movement of connecting rods 34 causes rotary or rotatable movement of crankshaft 20. The angle of rotation of crankshaft 20 is measured by engine 10 to aid in timing of combustion events in engine 10 and for other purposes. The angle of rotation of crankshaft 20 may be measured in a plurality of locations, including a main crank pulley (not shown), an engine flywheel (not shown), an engine camshaft (not shown), or on crankshaft 20 itself. Measurement of crankshaft 20 rotation angle may be made with toothed wheel sensor 62, rotary Hall sensor 64, and by other techniques. For example, a tone wheel may be associated with crankshaft 20 and a tone wheel may be associated with the camshaft and a tooth edge sensor or tooth sensor, such as an optical sensor, may be associated with each tone wheel. The signals from each sensor associated with a tone wheel may then be sent to a processor, such as the ECM, for processing to calculate the crankshaft angle. Two tone wheels may be required in the case where crankshaft 20 makes two rotations for one engine cycle to be able to determine where in the engine cycle the camshaft is positioned. Other sources of data may be used to determine the rotational position of crankshaft 20, such as data from pressure sensor 60. A signal representing the angle of rotation of crankshaft 20, also called the crank angle, is transmitted from toothed wheel sensor 62, rotary Hall sensor 64, or other device to control system 18.

Crankshaft 20 drives high-pressure fuel pump 46 and low-pressure fuel pump 50. The action of low-pressure fuel pump 50 pulls fuel from fuel tank 44 and moves the fuel along fuel circuit 42 toward inlet metering valve 52. From inlet metering valve 52, fuel flows downstream along fuel circuit 42 to high-pressure fuel pump 46. High-pressure fuel pump 46 moves the fuel downstream along fuel circuit 42 through outlet check valves 54 toward fuel accumulator or rail 48. Inlet metering valve 52 receives control signals from control system 18 and is operable to block fuel flow to high-pressure fuel pump 46. Inlet metering valve 52 may be a proportional valve or may be an on-off valve that is capable of being rapidly modulated between an open and a closed position to adjust the amount of fluid flowing through the valve.

Fuel pressure sensor 60 is connected with fuel accumulator 48 and is capable of detecting or measuring the fuel pressure in fuel accumulator 48. Fuel pressure sensor 60 sends signals indicative of the fuel pressure in fuel accumulator 48 to control system 18. Fuel accumulator 48 is connected to each fuel injector 38. Control system 18 provides control signals to fuel injectors 38 that determine operating parameters for each fuel injector 38, such as the length of time fuel injectors 38 operate, also called the on-time, which, together with the rail pressure, is used to calculate the amount of fuel delivered by each fuel injector 38.

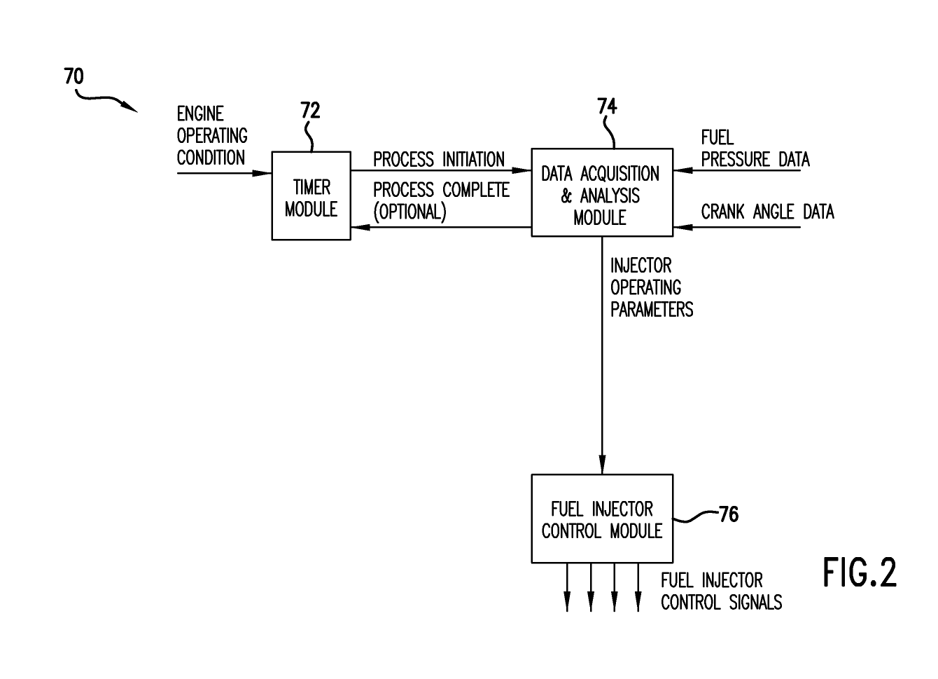

Control system 18 includes a process that controls certain components of engine 10 to enable adjustment of fuel delivery by each individual fuel injector 38. Turning now to FIG. 2, a data acquisition, analysis and control (DAC) module 70 in accordance with an exemplary embodiment of the present disclosure is shown. DAC module 70 includes a timer module 72, a data acquisition and analysis module 74, and a fuel injector control module 76.

Timer module 72 receives a signal indicative of an operating condition of engine 10 and may receive a process complete signal from data acquisition and analysis module 74. The function of timer module 72 is to initiate the data acquisition and analysis process of DAC module 70 when the operating condition of engine 10 permits. Timer module 72 may also optionally reinitiate a data acquisition and analysis process at intervals that may be specific and predetermined or may be adaptive to the operating condition of engine 10. In order to initiate the data acquisition process, timer module 72 initiates or starts a timing process using either the operating condition of engine 10 or, optionally, the completion of a previous data acquisition and analysis process. When engine 10 initially starts, timer module 72 receives the engine operating condition signal from control system 18 that indicates engine 10 is operating, which initiates a timer in timer module 72. When the timer reaches a specified or predetermined interval, timer module 72 generates and transmits a process initiation signal to data acquisition and analysis module 74. If data acquisition and analysis is performed for a limited period, described further hereinbelow, then subsequent timing processes are initiated from the optional process complete signal received from data acquisition and analysis module 74.

The engine operating condition signal may be a signal from control system 18 indicating that engine 10 is operating, meaning that high-pressure fuel pump 46 and fuel injectors 38 are operating. The engine operating condition signal may indicate that engine 10 is not operating properly. For example, engine 10 may have a fuel system malfunction that would cause fuel pressure sensor 60 to have erroneous readings. In another example, engine 10 may need to be within a certain performance range for DAC module 70 to operate correctly. In yet another example, engine 10 may be in a shutdown mode or may already have ceased operation. In any of these examples, pressure data from fuel pressure sensor 60 may be misleading, and DAC module 70 would either not operate or would stop operating on receipt of an engine operating signal indicative of engine 10 operation that would cause erroneous pressure signals from fuel pressure sensor 60.

Data acquisition and analysis module 74 receives the process initiation signal from timer module 72, engine crank angle data from internal combustion engine 10, and a fuel pressure data signal from fuel rail or accumulator pressure sensor 60. Module 74 generates and provides one or more injector operating parameter signals to fuel injector control module 76. Data acquisition and analysis module 74 may also optionally send a process complete signal to timer module 72 if the data acquisition process is conducted for a limited period.

When data acquisition and analysis module 74 receives the data acquisition initiation signal from flow control module 76, data acquisition and analysis module 74 begins to store fuel pressure data signals from accumulator pressure sensor 60, which are tagged with crank angle data to match the fuel pressure data signals to appropriate fuel injectors, discussed further hereinbelow. Data acquisition and analysis module 74 will then analyze the fuel pressure data signals to determine whether the operating parameters for one or more fuel injectors 38 needs to be modified. If one or more operating parameters for any fuel injector 38 require adjustment, module 74 will transmit the modified fuel injector operating parameters to fuel injector control module 76 for use in subsequent fuel injection events. Module 74 may continue receiving, storing, and analyzing pressure data continuously until engine 10 shuts down or module 74 may stop receiving, storing, and analyzing pressure data at the end of a predetermined interval. The reason module 74 may cease receiving, storing, and analyzing pressure data at the end of a predetermined interval is to conserve processing resources in control system 18. If module 74 ceases receiving, storing, and analyzing pressure data at a predetermined interval, module 74 sends the process complete signal to timer module 72. Timer module 72 then waits for an interval that may be predetermined or may adapt to operating conditions in engine 10 to transmit another process initiation signal to data acquisition and analysis module 74.

Fuel injector control module 76 receives fuel injector operating parameters from data acquisition and analysis module 74 and provides signals to each fuel injector 38 that control the operation of each fuel injector 38. For example, the operating parameters may include the duration of the injection event, which may be described as an injection event on-time or the time of operation for each fuel injector 38, and may include other operating parameters for each fuel injector 38.

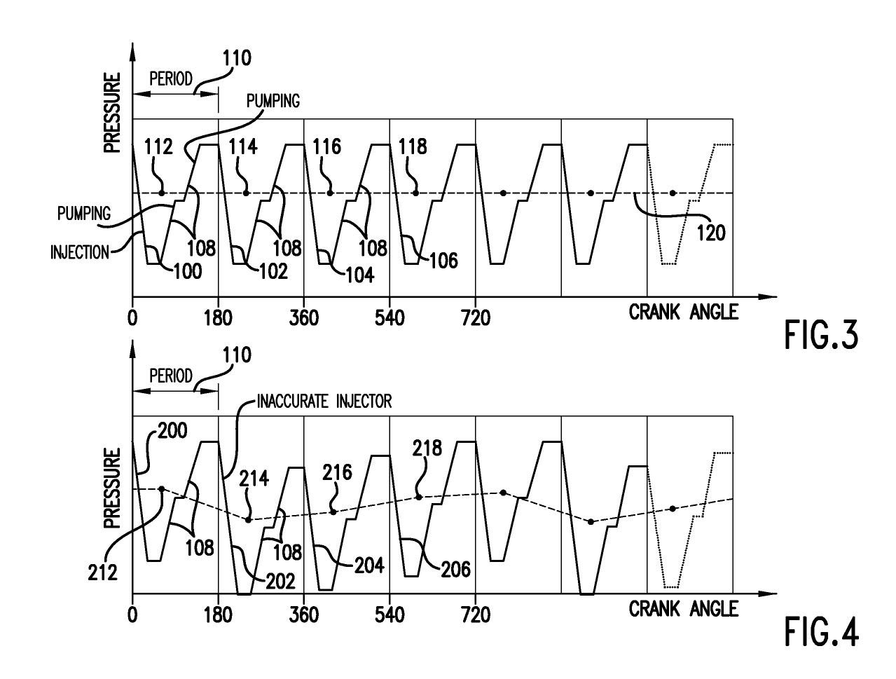

Turning now to FIG. 3, a graph of ideal or homogeneous fueling of all fuel injectors 38 is shown. The horizontal axis shows the crank angle of engine 10. The vertical axis shows the pressure in fuel rail or accumulator 48, which is greatly magnified in the region of interest rather than showing the vertical scale down to 0 bar. In the graph shown in FIG. 3, each fuel injector provides approximately the same amount of fuel, leading to a nearly equal pressure drop during injection events shown at 100, 102, 104, and 106. Injection event 100 may correspond with combustion chamber 40 associated with piston 22, injection event 102 may correspond with piston 26, injection event 104 may correspond with piston 28, and injection event 106 with piston 24. Between each injection event is one or more pumping events, shown at 108. In order to maintain the fueling balance, the number of pumping events between each injection event is the same. In the exemplary embodiment, from the beginning of one injection event to the beginning of a subsequent injection event is one injection period 110. More broadly, each injection period includes one injection event. Thus, each injection period extends from a crank angle prior to the beginning of one injection event to a crank angle after the end of the injection event. In an exemplary embodiment, each injection period extends from a crank angle prior to the beginning of one injection event to a crank angle after the end of the one injection event that corresponds to a beginning of a subsequent injection period, described further hereinbelow. However, the start or beginning of the one injection period may be offset from the beginning of an injection event and the end of the one injection period may be different from the beginning of a subsequent injection period, as will be described further hereinbelow. The period mean pressure during each injection period is shown at 112, 114, 116, and 118. A long-term average forms a straight line 120 because of the consistency of fueling from each fuel injector 38.

While FIG. 3 shows an ideal configuration, more typically there are variations between fuel injectors that lead to variations in fueling, such as those shown in FIG. 4, which shows fuel injection events 200, 202, 204, and 206, which may correspond to pistons 22, 26, 28, and 24. As in FIG. 3, from the beginning of one injection event to the beginning of a subsequent injection event is one injection period 110. Injection periods 110 that correspond to firing of each fuel injector 38 once is an engine cycle. Thus, one engine cycle includes one injection event from each one of the fuel injectors in engine 10. The period mean pressures during each injection period associated with fuel injection events 200, 202, 204, and 206 are 212, 214, 216, and 218. In this example, fuel injector 38 associated with piston 26 has inaccurate fueling, which may be seen during injection event 202. One way of compensating for the inaccuracy of fuel injector 38 associated with piston 26 is to measure the pressure drop in fuel rail or accumulator 48, and from that pressure drop calculate the amount of fuel injected by fuel injector 38 associated with piston 26. Once the amount of fuel is known, then control parameters for the respective fuel injector 38 may be adjusted, changing the amount of fuel injected for fuel injector 38 requiring adjustment. However, this method is intrusive in that it may require shutting off fuel flow to accumulator 48 and is subject to noise and other problems. The method of the present disclosure avoids the need to determine the amount of fuel provided by one or more fuel injectors 38.

In order to adjust an individual fuel injector 38, the period mean pressure for each injection period is calculated, the cycle mean pressure for all injection periods for one engine cycle is calculated, and using this data, the on-time for each fuel injector 38 is adjusted without resorting to calculating the amount of fuel injected. In the exemplary embodiment, engine 10 includes four pistons, fuel injectors 38, combustion chambers 40, etc., but the method of the present disclosure may be used for more than four pistons and as few as two pistons.

The pressure signal is divided into injection periods; each injection period is defined for convenience in terms of crank angle, but could also be defined in terms of time. Each injection period is defined as the crank angle length from a crank angle at or offset positively or negatively, from the beginning of one injection event to a crank angle after the end of the one injection event. A negative offset means the offset is prior to the beginning of the one injection event, and positive offset means that the offset is later or after the beginning of the one injection event. Each injection period includes at a portion of only one injection event, and that portion may be an entire injection event. The pressure during each of the four injection periods of the exemplary embodiment is defined as P(ca1,ca2), which is the pressure signal from crank angle 1 to crank angle 2. The pressure during each of the injection periods may also be defined as Pᵢ(h{i},h{i}+L), where the function h{i} may be defined in accordance with Equation (1).

$$h \{ i \} = a + \frac{Dcycle}{Ncyl} * ( i - 1 ) \qquad ( Equation 1 )$$

In Equation (1), the function of “a” is to provide an offset to the injection period, either positive or negative. As described hereinabove, when a fuel injector 38 injects fuel into a combustion chamber 40, the pressure in fuel accumulator 48 decreases. However, it takes time for the pressure decrease to be registered with pressure sensor 60. When the rotation speed of crankshaft 20 is relatively high, for example 1000 RPM or more, the time it takes for a pressure decrease to be registered in fuel accumulator 48 may be quite lengthy. Furthermore, pressure increases from high-pressure fuel pump 46 may be similarly delayed with respect to the crank angle. The function of “a” is to adapt the beginning of an injection period to possible delays in propagation in pressure signals to fuel accumulator 48. Because fuel systems may vary significantly, the value of “a” needs to be determined based on the specific delays in a particular fuel system, in addition to operating conditions of the engine in which a particular fuel system is located. Thus, “a” may be either a positive or negative value to best match an injection period window to the pressure changes from an injection event. While it is preferable to capture an entire injection event because it is most likely to yield the best accuracy, an injection period window may cut off a portion of each fuel injection event, i.e., start after the effects of a fuel injection event are reflected or measured by pressure sensor 60, as long as the start of each injection period window with respect to the start of the pressure signal reflective of an injection event is the same. However, while a portion of each fuel injection event may be cut off, cutting off too much of an injection event risks a significant error, leading to improper calculations and erroneous fueling. Thus, it is preferable to include one entire injection event within each injection period window, but a reduced amount of the injection event is acceptable with reduced accuracy. It should also be apparent from the foregoing discussion that each injection period or injection period window includes a portion of only one injection event, which may be an entire injection event or a part of an injection event. D_{cycle} is the engine cycle length, which in the exemplary embodiment is a crank angle of 720 degrees. N_{cyl} is the number of cylinders in the engine, which in the exemplary embodiment is four cylinders. “L” is the length of each injection period, which is in crank angle degrees in this example, which may be crank angle degrees or may be another angle that translates to the injection periods, and “i” extends from 1 to N_{cyl}. The purpose of the expression (i−1) is to provide the starting point in terms of crank angle for each of the injection periods. It should be further noted that while references are made to “period” and similar terms that may be interpreted to mean time, in the exemplary embodiment all measurements are in terms of degrees of a rotatable shaft, with the crankshaft used for convenience.

Because there are four injection periods in the exemplary embodiment, the pressure signals are divided into four periods or windows P(h{i},h{i}+L), where “i” is equal to 1, 2, 3 and 4. The instantaneous pressure is accumulated throughout each injection period. In an exemplary embodiment, pressure signals may be acquired at every crank tooth, which equates to every six degrees of crank angle. In order to reduce the effects of noise on the signal, the pressure signal may be averaged for “n” engine cycles, which is at least one cycle. Now four pressure indicators may be calculated as shown in Equations (2), (3), (4), and (5).

P₁=Averageₙ[P(h(1), h(1)+L)] (Equation 2)

P₂=Averageₙ[P(h(2),h(2)+L)] (Equation 3)

P₃=Averageₙ[P(h(3),h(3)+L)] (Equation 4)

P₄=Averageₙ[P(h(4),h(4)+L)] (Equation 5)

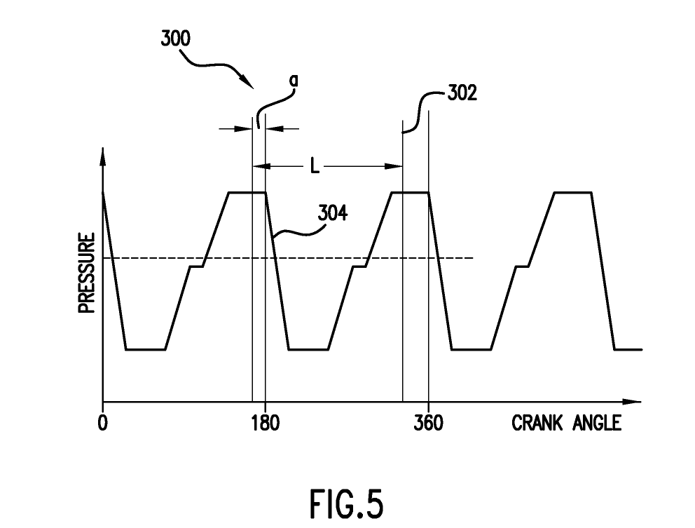

It should be apparent from the aforementioned equations that each injection period is defined as beginning at some crank angle “a” with respect to the start of an injection event 304, either positive or negative, which may be seen in FIG. 5 and which shows a representative injection period 300 in accordance with an exemplary embodiment of the present disclosure. As can be seen Equation (1), the injection period for each fuel injector 38 is selected in the second portion of Equation (1), using D_{cycle}, N_{cyl}, and “i.” The function of “L” is to define the length of the injection period, which extends from offset crank angle “a” to location 302. Note that none of the injection periods depend on each other. Thus, each injection period may overlap adjacent injection periods, they may be separate from adjacent injection periods, or they may be contiguous with adjacent injection periods. Furthermore, DAC module 70 may adjust the length of “a” and the length of “L” to attempt to best match an injection period window with an injection event, and to assure that the effects of any pumping events included in the injection period is consistent from one injection period to the next to assure analysis of each injection period is conducted in a manner that minimizes any systematic bias in the analysis that may be caused by inconsistent inclusion of pumping events. Such adjustments to “a” and “L” may be required based on engine speed, duration of an injection event, and other factors.

Now that the period mean pressures have been acquired for each injection period for n engine cycles, the pressure indicators, which are average pressures, are now used to find the cycle mean pressure for the four injection periods, using Equation (6).

$${P}_{mean} = \frac{P 1 + P 2 + P 3 + P 4}{4} \qquad ( Equation 6 )$$

Even though the calculations above are described as using mean or average calculations, median may substitute for mean or average in each place that mean or average appears. The result of calculations using the median is sufficiently close to the mean that the median is a suitable alternative.

Using the above pressure information, the on-time for each fuel injector may now be adjusted. Prior to determining an on-time adjustment, one additional factor needs predetermined, a correction factor K. Correction factor K provides the ability to adjust the rate at which the on-time for each fuel injector 38 is corrected. If correction factor K is too high, then the on-time may be over-corrected and the on-time will diverge or constantly oscillate between values that are too high and too low, rather than converging to a value that results in a homogenous pressure mean. Conversely, if correction factor K is too low, then the system response may be inadequate and it may take too long for the system to move to a homogeneous pressure mean, leading to decreased fuel efficiency and increased emissions. In the exemplary embodiment, correction factor K is approximately 0.001. As with “a” and “L” described hereinabove, correction factor K may be adjusted or adapted based on convergence or divergence tests. Thus, if correction factor K is too large and tends to cause a diverging solution, DAC module 70 may reduce correction factor K. If correction factor K is too small and causes a response that is too slow, DAC module 70 may increase correction factor K to achieve a converging solution faster without leading to divergence. The on-time of each fuel injector is now calculated using Equations (7), (8), (9), (10), and (11), where “i” corresponds to each of the injection periods above, which further corresponds to one fuel injector and may be phrased as i=1, . . . , N_{cyl}. In the exemplary embodiment, i=1, 2, 3, 4.

$$\begin{matrix} {Gain}_{i}^{previous} ← 1 & ( Equation 7 ) \\ {Gain}_{i}^{preliminary} ← {Gain}_{i}^{previous} - [ K * ( {P}_{i} - {P}_{mean} ) ] , & ( Equation 8 ) \\ {Gain}_{i}^{current} ← {Gain}_{i}^{preliminary} - ( \frac{{\sum }_{i = 1}^{Ncyl} {Gain}_{i}^{preliminary}}{Ncyl} - 1 ) & ( Equation 9 ) \\ {OnTime}_{i}^{current} ← {Gain}_{i}^{current} * {OnTime}_{i} & ( Equation 10 ) \\ {Gain}_{i}^{previous} ← {Gain}_{i}^{current} & ( Equation 11 )\end{matrix}$$

When control system 18 is first programmed, the value of Gainᵢ^{previous} is initially set. In the exemplary embodiment, the initial gain is set to “1,” as shown in Equation (7), which thus assumes that all fuel injectors are affecting the pressure level in fuel accumulator 48 by the same amount. As control system 18 identifies variations in the period mean pressure from the mean, the value of the Gain for each fuel injector will be adjusted dynamically. The function of Equation (8) is to identify pressure variations and to calculate an intermediate or preliminary gain, Gainᵢ^{preliminary} based on pressure variations in fuel rail or accumulator 48. The function of Equation (9) is to assure that total fueling will be maintained over all fuel injectors. To assure total fueling, Equation (9) calculates a current gain value for each fuel injector using Gainᵢ^{preliminary}. For example, if all preliminary gains are 1.1, Equation (9) will adjust the gains to 1.0 rather than having the gains exceed desired total fueling. The nominal on-time, OnTimeᵢ, for each fuel injector 38 is a nominal on-time based on the desired amount of fuel to be injected, fuel pressure in fuel accumulator 48, and other factors that may affect on-time. Equation (10) then functions to adjust the actual on-time of each injector based on the nominal on-time, as needed. Equation (11) sets current Gain to the previous Gain for the next round of calculations. When engine 10 shuts down, the last value of the previous Gain for each of the fuel injectors is saved in non-volatile memory and is used the next time engine 10 is started.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

I/We claim:

1. A method of adjusting an amount of fuel delivered by a fuel injector of an internal combustion engine having a plurality of fuel injectors, comprising:
determining a number of injection periods in an engine cycle, each injection period including a portion of an injection event and having an equal length, and the engine cycle including one injection event from each one of the plurality of fuel injectors;
calculating a period mean pressure in a fuel accumulator for each injection period in the engine cycle;
calculating a cycle mean pressure in the fuel accumulator for the engine cycle;
comparing the period mean pressure for each fuel injector to the cycle mean pressure; and
calculating an on-time for each fuel injector based on the comparison of the period mean pressure to the cycle mean pressure.

2. The method of claim 1, wherein a nominal on-time for each fuel injector is adjusted by multiplying the nominal on-time by a current gain and setting the result as a current on-time.

3. The method of claim 2, wherein the current gain is calculated by summing a plurality of preliminary gains, dividing the sum of by a number of cylinders in the engine, subtracting “1” from the result of the division, and subtracting the result from a preliminary gain for a respective fuel injector.

4. The method of claim 3, wherein the preliminary gain for a fuel injector is calculated by multiplying a difference between the respective period mean pressure for the fuel injector and the cycle mean pressure by a correction factor, and subtracting the result from a previous gain.

5. The method of claim 4, wherein the current gain is set as the previous gain for a subsequent on-time calculation.

6. The method of claim 1, wherein each injection period begins at a crank angle offset from a beginning of each respective injection event.

7. The method of claim 1, wherein the portion of the injection event is an entire injection event.

8. An internal combustion engine, comprising:
a control system;
a fuel accumulator;
a pressure sensor fluidly connected to the fuel accumulator and adapted to transmit a pressure signal indicative of a pressure in the fuel accumulator;
a plurality of fuel injectors fluidly connected to the fuel accumulator, each fuel injector of the plurality of fuel injectors being adapted to receive a control signal from the control system and having a current on-time in response to the control signal, the current on-time corresponding to an injection event;
a rotatable engine shaft;
an angle sensor associated with the rotatable engine shaft and adapted to transmit an angle signal indicative of an angle of rotation of the rotatable engine shaft; and
the control system adapted to receive the angle signal and the pressure signal during an engine cycle, the engine cycle divided into a plurality of injection periods and including one injection period for each fuel injector, the control system adapted to calculate a period mean pressure for each injection period, to calculate a cycle mean pressure for the engine cycle, to calculate a difference between each period mean pressure and the cycle mean pressure, and to use each difference to adjust a nominal on-time for each fuel injector to obtain the current on-time.

9. The internal combustion engine of claim 8, wherein each injection period extends from a beginning of a respective injection event to a crank angle after an end of the respective injection event.

10. The internal combustion engine of claim 8, wherein each injection period includes a portion of a respective injection event and a beginning of each injection period is offset from a beginning of the respective injection event.

11. The internal combustion engine of claim 8, wherein the nominal on-time for each fuel injector is adjusted by multiplying the nominal on-time by a current gain and setting the result as the current on-time.

12. The internal combustion engine of claim 11, wherein the current gain is calculated by summing a plurality of preliminary gains, dividing the sum of by a number of cylinders in the engine, subtracting “1” from the result of the division, and subtracting the result from the preliminary gain for a respective fuel injector.

13. The internal combustion engine of claim 12, wherein the preliminary gain for a fuel injector is calculated by multiplying a difference between the respective period mean pressure for the fuel injector and the cycle mean pressure by a correction factor, and subtracting the result from a previous gain.

14. The internal combustion engine of claim 13, wherein the current gain is set as the previous gain for a subsequent on-time calculation.

15. An internal combustion engine, comprising:
a control system;
a fuel accumulator;
a pressure sensor fluidly connected to the fuel accumulator and adapted to transmit a pressure signal indicative of a pressure in the fuel accumulator;
a plurality of fuel injectors fluidly connected to the fuel accumulator, each fuel injector of the plurality of fuel injectors being adapted to receive a control signal from the control system and having a current on-time in response to the control signal, the current on-time corresponding to an injection event;
a rotatable engine shaft;
an angle sensor associated with the rotatable engine shaft and adapted to transmit an angle signal indicative of the angle of rotation of the rotatable engine shaft; and
the control system adapted to receive the angle signal and the pressure signal for an engine cycle of 720 degrees of operation of the rotatable engine shaft, the engine cycle divided into a plurality of injection periods calculated by dividing 720 degrees by the number of fuel injectors in the plurality of fuel injectors, each injection period extending from a crank angle at or prior to a beginning of the injection event to a crank angle after the end of the injection event, and each injection period having the same crank angle length, the control system adapted to calculate a period mean pressure for each injection period, to calculate a cycle mean pressure for the engine cycle, to calculate a difference between each period mean pressure and the cycle mean pressure, and to use each difference to adjust a nominal on-time for each fuel injector to obtain the current on-time.

16. The internal combustion engine of claim 15, wherein the crank angle prior to the beginning of the injection event is 20 degrees.

17. The internal combustion engine of claim 16, wherein the nominal on-time for each fuel injector is adjusted by multiplying the nominal on-time by a current gain and setting the result as the current on-time.

18. The internal combustion engine of claim 17, wherein the current gain is calculated by summing a plurality of preliminary gains, dividing the sum of by a number of cylinders in the engine, subtracting “1” from the result of the division, and subtracting the result from the preliminary gain for a respective fuel injector.

19. The internal combustion engine of claim 18, wherein the preliminary gain for a fuel injector is calculated by multiplying a difference between the respective period mean pressure for the fuel injector and the cycle mean pressure by a correction factor, and subtracting the result from a previous gain.

20. The internal combustion engine of claim 19, wherein the current gain is set as the previous gain for a subsequent on-time calculation.
